(19) United States
(12) Patent Application Publication
(10) Pub. No.: US 2009/0175422 A1
(43) Pub. Date: Jul. 9, 2009

(54) SYSTEM AND METHOD FOR HANDLING COMMUNICATIONS PRESENTED TO A SPECIAL NUMBER ANSWERING POSITION

(75) Inventors: Monica Ann Marics, Boulder, CO (US); Robin Erkkila, Lafayette, CO (US)

Correspondence Address: MICHELLE A. ZARINELLI;C/O WEST CORPORATION, 11808 MIRACLE HILLS DR., MAIL STOP: W11-LEGAL, OMAHA, NE, 68154, US

(73) Assignee: WEST CORPORATION, Omaha, NE (US)

(21) Appl. No.: 11/969,978

(22) Filed: Jan. 7, 2008

(51) Int. Cl. H04M 11/04

(52) U.S. Cl. 379/45

(57) ABSTRACT

A system for handling communications presented in a first messaging protocol to a special number answering position using a second messaging protocol includes a translating unit coupled with the special number serving network and coupled with the answering position. The translating unit includes a plurality of first entries, a plurality of second entries and a plurality of correspondence indicators. Respective first correspondence indicators relate each respective first entry of the plurality of first entries with at least one respective second entry of the plurality of second entries. Respective second correspondence indicators relate each respective second entry with at least one respective first entry. Each respective first entry pertains to a character string expressed in the first messaging protocol. Each respective second entry pertains to a phrase expressed in the second messaging protocol.

### FIELD OF THE INVENTION

The present invention is directed to telecommunication systems, and especially to handling special number calls using a message format not employed by a special number answering position.

### BACKGROUND OF THE INVENTION

Special number services such as, by way of example and not by way of limitation, the Emergency Service E9-1-1 network in the United States, were implemented primarily in a voice network. The relatively recent introduction of text message (also referred to as text messaging) formats conveyed via a signaling channel of voice networks has provided additional capabilities for the E9-1-1 network as well as other special number networks.

Use of non-voice communication formats or protocols such as text message formats for communicating with a special number answering position such as, by way of example and not by way of limitation, a Public Safety Answering Position (PSAP; sometimes referred to as a Public Safety Answering Point) in an E9-1-1 network will require that a PSAP be capable of receiving and responding to emergency service requests using a text message format.

Employing a text message format for communicating can involve burdensome character entry and length limitations. Text entry may be especially burdensome when certain communication devices are used such as, by way of example and not by way of limitation, a mobile phone that is not equipped with a keyboard entry facility. To overcome such burdensome data entry, text messaging users have developed abbreviations, initialisms and acronyms. Such user-developed acronyms and abbreviations have so far evolved in an ad hoc manner, and are continuing to evolve. Some of the acronyms and abbreviations presently in use are intuitively recognizable, and others may be less obvious or imprecise in their meaning.

As text messaging to a PSAP becomes more common, a translation engine or unit is needed to convert acronyms and abbreviations to plain text that PSAP operators can be relied upon to understand. Also, when a PSAP operator enters a response to a user, the response may need to be converted back to an abbreviated form to compensate for text message length limitations imposed upon some text messaging formats.

A translation engine or unit can also be useful for converting error or information codes generated by electronic equipment into full text messages for a PSAP or other special number call taker, such as a maintenance facility call taker. By way of example and not by way of limitation, a heart monitor may generate a coded output message when dangerous readings are detected. With a properly configured translation engine, such a coded message can be translated into full text so a PSAP can determine an appropriate response to the coded message. Such a code-to-plain text translation capability may be advantageously employed with other electronic devices such as, by way of example and not by way of limitation, car sensors, oil well sensors, home security systems, radiation monitors, water quality sensors, personal safety alarms or another sensor or alarm that may contact a PSAP with a public safety request or contact another special number call taker with a request.

A translation engine may also be advantageously configured to translate between languages, so that a PSAP can respond in English text, and the translation engine will translate that text to the language of the original message (e.g. Spanish or French).

There is a need for a system and method for handling communications presented in a first messaging protocol to a special number answering position using a second messaging protocol.

### SUMMARY OF THE INVENTION

A system for handling communications presented in a first messaging protocol to a special number answering position using a second messaging protocol includes a translating unit coupled with the special number serving network and coupled with the answering position. The translating unit includes a plurality of first entries, a plurality of second entries and a plurality of correspondence indicators. Respective first correspondence indicators relate each respective first entry of the plurality of first entries with at least one respective second entry of the plurality of second entries. Respective second correspondence indicators relate each respective second entry with at least one respective first entry. Each respective first entry pertains to a character string expressed in the first messaging protocol. Each respective second entry pertains to a phrase expressed in the second messaging protocol.

A method for handling communications presented in a first messaging protocol to a special number answering position using a second messaging protocol includes (a) providing a translating engine unit coupled with the special number serving network and coupled with the special number answering position; (b) in no particular order: (1) populating the translating unit with a plurality of first entries; each respective first entry pertaining to a character string expressed in the first messaging protocol; (2) populating the translating unit with a plurality of second entries; each respective second entry pertaining to a phrase expressed in a form appropriate for use by the special number answering position; and (3) populating the translating unit with a plurality of correspondence indicators; (c) employing respective first correspondence indicators of the plurality of correspondence indicators for relating each respective first entry of the plurality of first entries with at least one respective second entry of the plurality of second entries; and (d) employing respective second correspondence indicators of the plurality of correspondence indicators relating each respective second entry with at least one respective first entry.

It is, therefore a feature of the present invention to provide a system and method for handling communications presented in a first messaging protocol to a special number answering position using a second messaging protocol.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram illustrating a system for handling communications presented in a first messaging protocol to a special number answering position using a second messaging protocol.

FIG. 2 is a schematic diagram illustrating details of the translation engine illustrated in FIG. 1.

FIG. 3 is a flow diagram illustrating a method for handling communications presented in a first messaging protocol to a special number answering position using a second messaging protocol.

### DETAILED DESCRIPTION

For purposes of illustration, by way of example and not by way of limitation, the present invention will be discussed in the context of an emergency service network in the United States, commonly referred to as an E9-1-1 network. The teachings of the present invention are equally applicable, useful and novel in other special number calling systems, such as maintenance service networks, college campus security networks and other networks.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

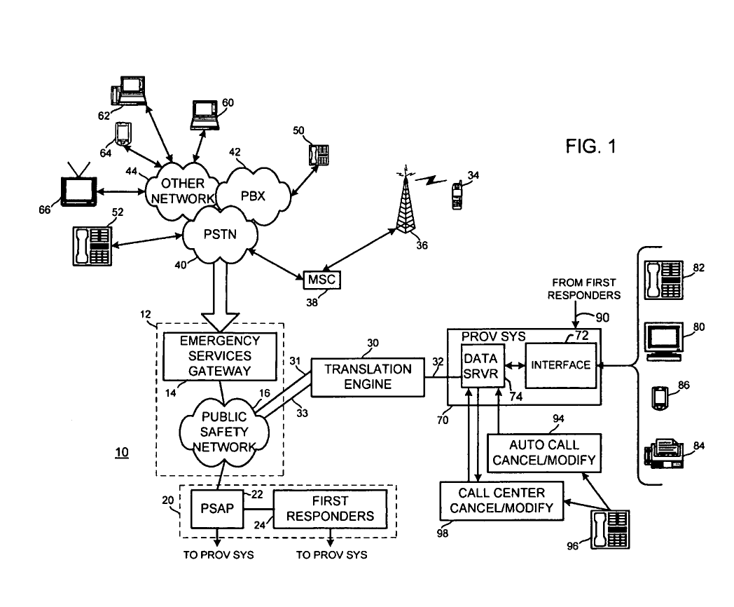

FIG. 1 is a schematic diagram illustrating a system for handling communications presented in a first messaging protocol to a special number answering position using a second messaging protocol. In FIG. 1, a generic representation of a special number call system is illustrated by an emergency services call system 10. System 10 includes a special number serving facility 12. Special number serving facility 12 includes a gateway and a network; in the exemplary system 10 illustrated in FIG. 1, special number serving facility 12 is embodied in an emergency services serving facility including an emergency services gateway 14 coupled with a public safety network 16. Emergency services gateway 14 may be embodied, by way of example and not by way of limitation, in a selective router or a tandem switch or in another unit familiar with those skilled in the art of emergency service communication network design.

Public safety network 16 is coupled for communication with a special number answering position 20; in the exemplary system 10 illustrated in FIG. 1, special number answering position 20 is embodied in at least one PSAP (Public Safety Answering Position) 22 with associated communicatively coupled first responders 24. First responders 24 represents various first responder entities that can be contacted by PSAP 20 including, by way of example and not by way of limitation, police, fire fighting, search and rescue, ski patrol, medical and other responding entities (not shown in detail in FIG. 1).

A translation engine or unit 30 is coupled with public safety network 16 via a translation input line 31 and a translation output line 33 for translating communications in a first messaging protocol to a translated message in a second messaging protocol, and for translating communications in the second messaging protocol to a translated message in the first messaging protocol. The first messaging protocol, by way of example and not by way of limitation, may be a text messaging protocol. Text messaging communication may employ a format such as Short Message Service (SMS), Unstructured Supplementary Service Data (USSD), Instant Messaging (IM) or Multimedia Messaging Service (MMS) and may be conveyed using control channels or other communication channels associated with a telecommunication network. Other protocols may as well be employed for preparing and conveying a message in the first message protocol including, by way of example and not by way of limitation, and non-voice message protocol.

Translation engine 30 may be coupled with one or more other elements of system 10 if desired including, but not limited to, selected first responders 24 or PSAPs 22.

E9-1-1 emergency calls are received by emergency services gateway 14 from any of a variety of networks including, by way of example and not by way of limitation, a PSTN (Public Switched Telephone Network) 40, a PBX (Private Branch eXchange) network 42, other networks 44 (e.g., an Internet Protocol network), or a combination of networks 40, 22, 44. Thus, a caller or service requester from a phone 50 associated with private branch exchange 42 may place a 9-1-1 call that will be routed via PBX network 42 and PSTN 40 to emergency services gateway 14. Similarly, a caller from a phone 52 may place a 9-1-1 call via PSTN 40 to emergency services gateway 14. A caller or service requester may use other communication devices such as a personal computer (PC) 60, a VoIP (Voice over Internet Protocol) phone 62, a PDA (Personal Digital Assistant) 64 or an interactive TV system 66 to place an emergency services request (e.g. a 9-1-1 call) using voice, a key pad or SMS (Short Messaging System) or another message format via one or more of other networks 44 (e.g., an Internet Protocol network or other public network or a private network) and PSTN 20 to reach emergency services gateway 14. A mobile phone 34 may be used to place a 9-1-1 call via a mobile tower 36, an MSC (Mobile Switching Center) 38 and PSTN 40 to emergency services gateway 14. Mobile phone 34 may also place a 9-1-1 call using a WiFi (Wireless Local Area Network) network, where mobile phone 34 uses a modem or a RF (radio frequency) hot spot (not shown in FIG. 1, but known by those skilled in the art of telecommunication network design) coupled with an IP network, represented by other network 44, then connected to MSC 38 and routed to the PSAP 22 via the PSTN 40 and emergency services gateway 14. An RF hot spot provides localized wireless coverage using any number of technologies.

Mobile phone 34 may be used to originate communications using SMS (Short Message Service) or MMS (Multi-media Message Service). SMS and MMS calls may be routed via an IP network or other network via an SMSC (Short Message Service Center) or MMSC (Multi-media Message Service center) to emergency services gateway 14 directly, via PSTN 40 or via another routing. Such various routing of telecommunications to emergency services gateway 14 are known to those skilled in the art of telecommunication network design and are not specifically illustrated here in the interest of avoiding cluttering FIG. 1.

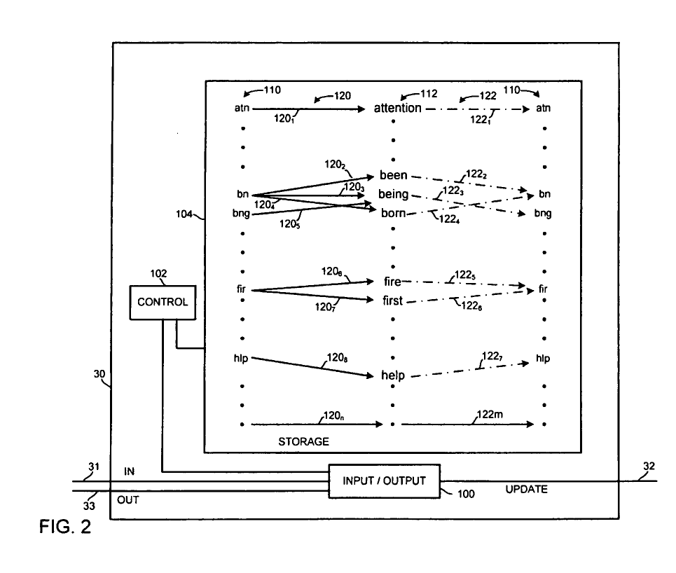

In the representative embodiment illustrated in FIG. 1, translation engine 30 is also coupled with a provisioning system 70 via an update line 32. Provisioning system 70 includes an interface 72 and a data server 74. Data server 74 represents one or more data storage unit or units and an associated server for accessing that data storage unit or units. Data server 74 may be embodied in any server and associated data storage unit (or units) configured to permit remote access to data stored in data server 74 and alteration of data stored in data server 74. Information required for establishing and defining first entries, second entries and associated correspondence indicators (explained in greater detail in connection with FIG. 2) is provided to interface 72 of provisioning system 70 by authorized users such as subscribers, PSAP personnel, electronic equipment manufacturers or other users deemed appropriate to have access for modifying contents of translation engine 30.

Alterations or updates to contents of translation engine 30 may be effected by any one of several methods for submitting change information to interface 72 for inclusion in data server 74 such as, by way of example and not by way of limitation: via a computer 80 to send an e-mail via the Internet; calling a personal 9-1-1 representative using a phone 82; calling an IVR (Interactive Voice Response) system (not shown in FIG. 1) using a phone 82 to connect with data server 74 to effect the desired subscription or changes. Other methods for submitting or changing personal information stored in data server 74 include mailing in a personal information form via the postal service; using computer 80 to enter information to a web site provided for receiving updates to data server 74; submitting information via a facsimile machine 84; submitting information via a VoIP (Voice Over IP) connection (not shown in FIG. 1); submitting information using a PDA (Personal Digital Assistant) 86 or similar wireless device or by another communication method.

For those submission methods not involving a human operator, an authorized user submits change information using a respective submission method and a personal 9-1-1 application program (preferably located in interface 72), receives the change information, validates that the sender is an authorized user and sends the change information to data server 74 to apply the data stored in a database associated with data server 74 or to integrate the information directly with a database (not shown in FIG. 1) within translation engine 30. Methods that involve a human operator may operate similarly except that instead of an authorized user submitting personal 9-1-1 data directly to data server 74, a human operator enters the information to data server 74 on the authorized user's behalf either directly from a phone call or after receipt of the information via an electronic submission method such as e-mail, entry of information into a web site, facsimile (FAX), or another method.

Provisioning system 70 can be coupled with an automatic call facility 94 for effecting automated modification of aspects of data stored by data server 74 in response to calls placed by a caller using a phone 96. Provisioning system 70 is also coupled with a call center 98 for responding to human intervention to modify of aspects of data stored by data server 74. The human intervention provided from call center 98 is occasioned by instructions issued by a caller using phone 96. An authorized user may also access automatic call facility 94 and call center 98 using any of the various other communication instruments and systems used to access provisioning system 70 including a computer, a phone, a facsimile machine, a VoIP (Voice Over IP) connection, a PDA (Personal Digital Assistant) or similar wireless device or by another communication method (not shown in FIG. 1).

In an exemplary situation, a caller may place an emergency service request call from any of phone 50, phone 52, PC 60, VoIP phone 62, PDA 64 or other communication in the following text:
Hlp, sum1 jst kidnapped me n I'm bn held hostage. I cnt tlk or he'll heA me. Hlp!

A properly populated translation engine 30 will receive the above message via translation input line 31 from public safety network 16 and return a translated passage via translation output line 33 to public safety network 16 for further transfer to PSAP 22 as follows:
“Help, someone just kidnapped me and I'm being held hostage. I can't talk or he'll hear me. Help!”

PSAP 22 may respond with the phrase:
“Help is on the way.”

A properly populated translation engine 30 will receive the above message via translation input line 31 from PSAP 22 via public safety network 16 and return a translated passage via translation output line 33 to public safety network 16 for further transfer to the original caller as follows:
Hlp otw.

A preferred embodiment of the present invention will include the following functional capabilities: (1) Updateable database of initialisms, acronyms, abbreviations, manufacturer error and alert codes and other first protocol expressions. (2) Capability for updating data bases in the translation engine or unit by users such as, by way of example and not by way of limitation, public safety entities, end 9-1-1 users, manufacturers of electronic equipment and other entities provided access to the data base. (3) A bi-directional translation capability to translate messages incoming to the special number answering position and to translate messages outgoing from the special number answering position. (4) Processing engine designed for generating a most likely translation plus other possible alternative translations, preferably ranked by likelihood or some other statistical analysis, and providing all of the various translations for viewing by the special number answering position. (5) Capability for the special number answering position to turn the translation engine on or off for each message sent or received. (6) Capability for the special number answering position to be able to see the translated message and also access the original abbreviation. (7) Capability to provide translations that apply nationally as well as a capability to provide translations that relate to a specific geographic region or to specific users. By way of example and not by way of limitation, the term or phrase “hlp” may translate to “help” nationally. The term “RMP” may translate to “Rocky Mountain Park” only if the request is made along the Front Range of Colorado. A diabetic cell phone user might register a code of “111” to translate to “low blood sugar alert”. This latter translation may be designated for such a translation only when the “111” code originates from the cell phone of a previously registered end user. (8) Translations include from acronyms or abbreviations to full English, or translations between languages (multi-lingual support). (9) The translation engine will work with electronic devices and any device with a text client such as cell phones, PDAs (Personal Digital Assistant), computer, or the like. (10) The translation engine may be accessed via a network, including the Internet. (1) All transactions are logged to include information such as, by way of example and not by way of limitation, timestamps, any known location, original text or code, translated plain text, identification of origination device, and call destination.

FIG. 2 is a schematic diagram illustrating details of the translation engine illustrated in FIG. 1. In FIG. 2, translation engine or unit 30 includes an input/output element 100 coupled with translation input line 31, with translation output line 33 and with update line 32 (see FIG. 1). Input/output element 100 is coupled with a control element 102. Control element 102 is coupled with a storage element 104.

Storage element 104 includes stored first entries 110 and stored second entries 112. First entries 110 relate or pertain to character strings expressed in a first messaging protocol such as, by way of example and not by way of limitation, messages received from a caller in a text messaging SMS protocol via public safety network 16 and translation input line 31 (FIG. 1). Second entries 112 relate or pertain to character strings expressed in a second messaging protocol useful at PSAP 22 (FIG. 1) such as, by way of example and not by way of limitation, messages expressed in plain text or in voice format.

Storage element 104 also includes stored first correspondence indicators 120 relating respective first entries 110 with at least one second entry 112, and stored second correspondence indicators 122 relating respective second entries 112 with at least one first entry 110.

For example, a first correspondence indicator 120₁ relates first entry atn with a second entry “attention”. A first correspondence indicator 120₂ relates first entry bn with second entry “been”. A first correspondence indicator 120₃ relates first entry bn with second entry “being”. A first correspondence indicator 120₄ relates first entry bn with second entry “born”. A first correspondence indicator 120₅ relates first entry bng with second entry “being”. A first correspondence indicator 120₆ relates first entry fir with second entry “fire”. A first correspondence indicator 120₇ relates first entry fir with second entry “first”. A first correspondence indicator 120₈ relates first entry hlp with second entry “help”. Other first correspondence indicators 120n will relate other respective first entries 110 with at least one second entry 112. The indicator “n” is employed to signify that there can be any number of first correspondence indicators in storage element 104. The inclusion of nine first correspondence indicators 120₁, 120₂, 120₃, 120₄, 120₅, 120₆, 120₇, 120₈, 120ₙ in FIG. 2 is illustrative only and does not constitute any limitation regarding the number of first correspondence indicators that may be included in the storage element of the present invention.

A second correspondence indicator 122₁, relates second entry “attention” with first entry atn. A second correspondence indicator 122₂ relates second entry “been” with first entry bn. A second correspondence indicator 122₃ relates second entry “being” with first entry bng. A second correspondence indicator 122₄ relates second entry “born” with first entry bn. A second correspondence indicator 122₅ relates second entry “fire” with first entry fir. A second correspondence indicator 122₆ relates second entry “first” with first entry fir. A second correspondence indicator 122₇ relates second entry “help” with first entry hlp. Other second correspondence indicators 120m will relate other respective second entries 112 with at least one first entry 110. The inclusion of eight first correspondence indicators 122₁, 122₂, 122₃, 122₄, 122₅, 122₆, 122₇, 122ₘ in FIG. 2 is illustrative only and does not constitute any limitation regarding the number of second correspondence indicators that may be included in the storage element of the present invention.

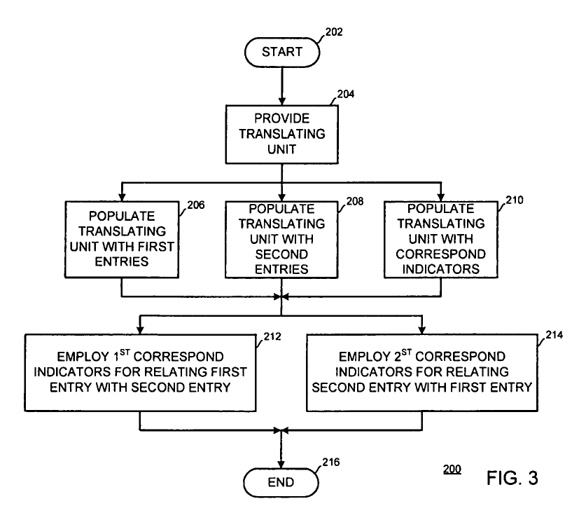

FIG. 3 is a flow diagram illustrating a method for handling communications presented in a first messaging protocol to a special number answering position using a second messaging protocol. In FIG. 3, a method 200 for handling communications presented in a first messaging protocol to a special number answering position via a special number serving network begins at a START locus 202. The special number answering position operates using a second messaging protocol.

Method 200 continues with providing a translating engine unit coupled with the special number serving network and coupled with the special number answering position, as indicated by a block 204.

Method 200 continues with, in no particular order: (1) populating the translating unit with a plurality of first entries, as indicated by a block 206; (2) populating the translating unit with a plurality of second entries, as indicated by a block 208; and (3) populating the translating unit with a plurality of correspondence indicators, as indicated by a block 210. Each respective first entry pertains to a character string expressed in the first messaging protocol. Each respective second entry pertains to a phrase expressed in the second messaging protocol.

Method 200 continues with, in no particular order: (1) employing respective first correspondence indicators of the plurality of correspondence indicators for relating each respective first entry of the plurality of first entries with at least one respective second entry of the plurality of second entries, as indicated by a block 212; and (2) employing respective second correspondence indicators of the plurality of correspondence indicators for relating each respective second entry with at least one respective first entry, as indicated by a block 214.

Method 200 terminates at an END locus 216.

It is to be understood that, while the detailed drawings and specific examples given describe embodiments of the invention, they are for the purpose of illustration only, that the system and method of the invention are not limited to the precise details and conditions disclosed and that various changes may be made therein without departing from the spirit of the invention which is defined by the following claims:

1. A system for handling communications presented in a first messaging protocol to a special number answering position; the special number answering position operating using a second messaging protocol; the system comprising: a translating engine unit coupled with said special number serving network and coupled with said special number answering position; said translating unit including a plurality of first entries, a plurality of second entries and a plurality of correspondence indicators; respective first correspondence indicators of said plurality of correspondence indicators relating each respective first entry of said plurality of first entries with at least one respective second entry of said plurality of second entries; respective second correspondence indicators of said plurality of correspondence indicators relating each said respective second entry with at least one said respective first entry; each said respective first entry pertaining to a character string expressed in said first messaging protocol; each said respective second entry pertaining to a phrase expressed in said second messaging protocol.

2. A system for handling communications presented in a first messaging protocol to a special number answering position via a special number serving network as recited in claim 1 wherein each said respective first correspondence indicator is substantially integrally stored with at least one selected said first entry of said plurality of first entries.

3. A system for handling communications presented in a first messaging protocol to a special number answering position via a special number serving network as recited in claim 1 wherein each said respective second correspondence indicator is substantially integrally stored with at least one selected said second entry of said plurality of second entries.

4. A system for handling communications presented in a first messaging protocol to a special number answering position via a special number serving network as recited in claim 2 wherein each said respective second correspondence indicator is substantially integrally stored with at least one selected said second entry of said plurality of second entries.

5. A system for handling communications presented in a first messaging protocol to a special number answering position via a special number serving network as recited in claim 1 wherein the system further comprises a communication entity coupled with said translating engine; said communication entity being configured for effecting change of at least one of said plurality of first entries, said plurality of second entries and said plurality of correspondence indicators in said translating engine.

6. A system for handling communications presented in a first messaging protocol to a special number answering position via a special number serving network as recited in claim 2 wherein the system further comprises a communication entity coupled with said translating engine; said communication entity being configured for effecting change of at least one of said plurality of first entries, said plurality of second entries and said plurality of correspondence indicators in said translating engine.

7. A system for handling communications presented in a first messaging protocol to a special number answering position via a special number serving network as recited in claim 4 wherein the system further comprises a communication entity coupled with said translating engine; said communication entity being configured for effecting change of at least one of said plurality of first entries, said plurality of second entries and said plurality of correspondence indicators in said translating engine.

8. A system for handling communications presented in a first messaging protocol to an emergency service answering position; the emergency service answering position operating using a second messaging protocol; the system comprising: a translating engine unit coupled with said emergency service network and coupled with said emergency service answering position; said translating unit including a plurality of first entries, a plurality of second entries and a plurality of correspondence indicators; respective first correspondence indicators of said plurality of correspondence indicators relating each respective first entry of said plurality of first entries with at least one respective second entry of said plurality of second entries; respective second correspondence indicators of said plurality of correspondence indicators relating each said respective second entry with at least one said respective first entry; each said respective first entry pertaining to a character string expressed in said first messaging protocol; each said respective second entry pertaining to a phrase expressed in said second messaging protocol.

9. A system for handling communications presented in a first messaging protocol to an emergency service answering position via an emergency service network as recited in claim 8 wherein each said respective first correspondence indicator is substantially integrally stored with at least one selected said first entry of said plurality of first entries.

10. A system for handling communications presented in a first messaging protocol to an emergency service answering position via an emergency service network as recited in claim 8 wherein each said respective second correspondence indicator is substantially integrally stored with at least one selected said second entry of said plurality of second entries.

11. A system for handling communications presented in a first messaging protocol to an emergency service answering position via an emergency service network as recited in claim 9 wherein each said respective second correspondence indicator is substantially integrally stored with at least one selected said second entry of said plurality of second entries.

12. A system for handling communications presented in a first messaging protocol to an emergency service answering position via an emergency service network as recited in claim 8 wherein the system further comprises a communication entity coupled with said translating engine; said communication entity being configured for effecting change of at least one of said plurality of first entries, said plurality of second entries and said plurality of correspondence indicators in said translating engine.

13. A system for handling communications presented in a first messaging protocol to an emergency service answering position via an emergency service network as recited in claim 9 wherein the system further comprises a communication entity coupled with said translating engine; said communication entity being configured for effecting change of at least one of said plurality of first entries, said plurality of second entries and said plurality of correspondence indicators in said translating engine.

14. A system for handling communications presented in a first messaging protocol to an emergency service answering position via an emergency service network as recited in claim 11 wherein the system further comprises a communication entity coupled with said translating engine; said communication entity being configured for effecting change of at least one of said plurality of first entries, said plurality of second entries and said plurality of correspondence indicators in said translating engine.

15. A method for handling communications presented in a first messaging protocol to a special number answering position; the special number answering position operating using a second messaging protocol; the method comprising:
(a) providing a translating engine unit coupled with said special number serving network and coupled with said special number answering position;
(b) in no particular order:
(1) populating said translating unit with a plurality of first entries; each said respective first entry pertaining to a character string expressed in said first messaging protocol;
(2) populating said translating unit with a plurality of second entries; each said respective second entry pertaining to a phrase expressed in said second messaging protocol; and
(3) populating said translating unit with a plurality of correspondence indicators; and
(c) in no particular order:
(1) employing respective first correspondence indicators of said plurality of correspondence indicators for relating each respective first entry of said plurality of first entries with at least one respective second entry of said plurality of second entries; and
(2) employing respective second correspondence indicators of said plurality of correspondence indicators relating each said respective second entry with at least one said respective first entry.

16. A method for handling communications presented in a first messaging protocol to a special number answering position via a special number serving network as recited in claim 15 wherein each said respective first correspondence indicator is substantially integrally stored with at least one selected said first entry of said plurality of first entries.

17. A method for handling communications presented in a first messaging protocol to a special number answering position via a special number serving network as recited in claim 15 wherein each said respective second correspondence indicator is substantially integrally stored with at least one selected said second entry of said plurality of second entries.

18. A method for handling communications presented in a first messaging protocol to a special number answering position via a special number serving network as recited in claim 16 wherein each said respective second correspondence indicator is substantially integrally stored with at least one selected said second entry of said plurality of second entries.

19. A method for handling communications presented in a first messaging protocol to a special number answering position via a special number serving network as recited in claim 15 wherein the system further comprises a communication entity coupled with said translating engine; said communication entity being configured for effecting change of at least one of said plurality of first entries, said plurality of second entries and said plurality of correspondence indicators in said translating engine.

20. A method for handling communications presented in a first messaging protocol to a special number answering position via a special number serving network as recited in claim 16 wherein the system further comprises a communication entity coupled with said translating engine; said communication entity being configured for effecting change of at least one of said plurality of first entries, said plurality of second entries and said plurality of correspondence indicators in said translating engine.
